(19) United States
(12) Patent Application Publication
(10) Pub. No.: US 2009/0165144 A1
(43) Pub. Date: Jun. 25, 2009

(54) CONTRACTED PRODUCT SUPPLY METHOD, CLIENT DEVICE, SERVER AND RECORDING MEDIUM HAVING PROGRAM RECORDED THEREIN

(75) Inventor: Masaki Fujita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/338,000

(22) Filed: Dec. 18, 2008

(30) Foreign Application Priority Data
Dec. 19, 2007 (JP) 2007-327797

(51) Int. Cl. G06F 21/00

(52) U.S. Cl. 726/26

(57) ABSTRACT

A contracted product supply method includes a notifying step of sending identification information to a server, an extracting step of extracting contract information, a transmitting step of transmitting the contract information, a certifying step of certifying permission and a setting step of setting a license of the contracted software products certified in the certifying step.

### BACKGROUND OF THE INVENTION

1. Field of the Invention

The present invention relates to a contracted product supply method, a client device, a server and a program-recorded recording medium that are relevant to permission to use an application program operating on a computer.

2. Description of the Related Art

When a personal computer (hereinafter referred to as “PC”) is sold, the following selling styles are normally adopted. As a first sale style, a personal computer in which OS (Operating System) and basic applications have been installed is sold. As a second sale style, a personal computer in which no application has not been installed is sold, and a user afterwards installs any application into the computer.

Personal computers introduced into companies frequently adopt the latter sale style because required applications are special. However, it is very cumbersome for a user to obtain necessary applications and install them into a personal computer.

There is a method of selling a recording medium having various kinds of applications recorded therein and the main body of a PC in combination (as a set), and making it possible to install only contracted applications into the PC. In order to prevent non-contracted applications from being unjustly installed into PC, it is individually judged on the basis of contract information attached to the recording medium whether each application can be installed.

In the above related art, the contract information for determining whether an application can be installed or not is attached to the recording medium. Therefore, when the recording medium is lost or damaged somewhere on the way to delivery, it is necessary to re-deliver a recording medium with the appropriate contract information.

That is, a recording medium having the contract information to be re-delivered is created again, and the recording medium concerned is re-delivered to the contractant. As a result, the working load of the selling source is increased, and it takes much time to complete the installation of an application. Furthermore, when the contract content is changed, a recording medium having the changed contract information must be re-delivered, and the same problem as described above occurs.

Furthermore, it is necessary for human beings to check the release timings of the latest versions of contracted applications. Therefore, the work load is further increased, and also check errors may occur in the release timing. Accordingly, it is difficult to keep the contracted applications current.

### SUMMARY

The present invention has been implemented in view of the foregoing situation, and has an object to provide a contracted product supply method, a client apparatus, a server and a program-recorded recording medium with which a load and the time required to install contracted software products can be reduced and shortened, by collectively giving a license (permission of use) of software products to every contractant.

In order to attain the above object, a contracted product supply method comprises: providing identification information of a client device having a software product installed therein to a server that is connected to the client server so as to be in mutual communication with each other and manage contract information concerning the software product, the software product concerned being permitted to be used when specific contract information is given to the client device; extracting contract information associated with the notified identification information from a contract information data base of the server; transmitting the extracted contract information from the server to the client device; certifying permission of the use of contracted software products out of software products installed in the client device on the basis of the specific contract information and the contract information transmitted from the server by the client device; and setting a license of the certified contracted software products.

### BRIEF DESCRIPTION OF THE DRAWINGS

FIG. 1 is a system construction diagram of a contracted product supply system;

FIG. 2 is a diagram showing a storage content of a CD-ROM;

FIG. 3 is a diagram showing a storage content of a contract information DB;

FIG. 4 is a block diagram showing the hardware construction of a computer device;

FIG. 5 is a block diagram showing the functional construction of the contracted product supply system;

FIG. 6 is a diagram showing a specific example of contract information;

FIG. 7 is a diagram showing a specific example of file information;

FIG. 8 is a diagram showing a specific example of a table list in which software products and operation objects are associated with one another;

FIG. 9 is a diagram showing a specific example of a table list representing the relevance of the software products;

FIG. 10 is a diagram showing a specific example of an actuation status list;

FIG. 11 is a diagram showing a specific example of update information list;

FIG. 12 is a diagram showing a screen example of a display;

FIG. 13 is a sequence diagram showing an example of the processing flow of the contracted product supply system;

FIG. 14 is a sequence diagram showing an example of the update processing flow; and

FIG. 15 is a flowchart showing an example of the processing flow of creating the actuation status list.

### DETAILED DESCRIPTION OF THE PREFERRED EMBODIMENTS

Preferred embodiments of a contracted product supply method, a client device, a server and a program-recorded recording medium will be described hereunder in detail with reference to the accompanying drawings.

(System Construction of Contracted Product Supply System)

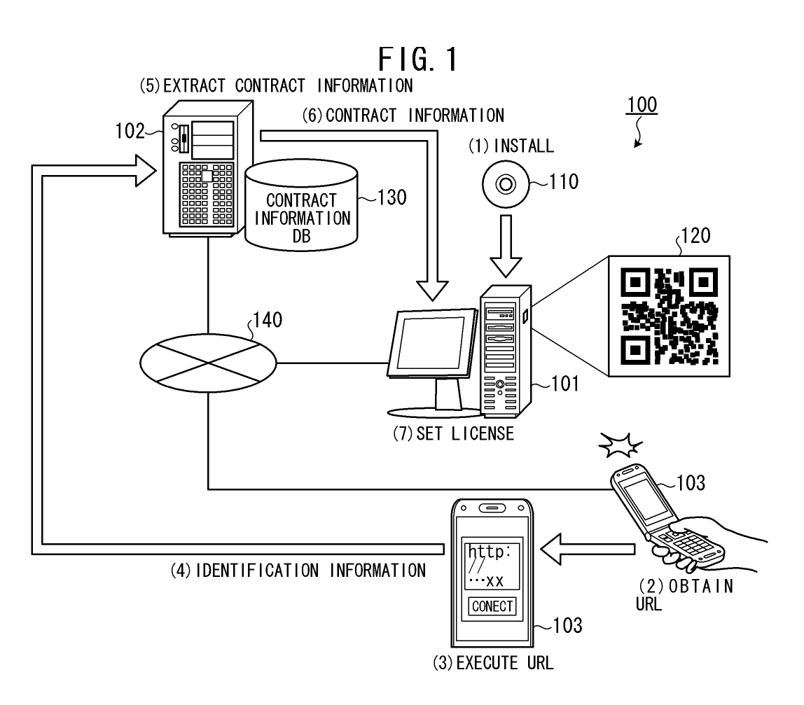

First, the system construction of the contracted product supply system according to an embodiment will be described. FIG. 1 is a system construction diagram showing the contracted product supply system. In FIG. 1, a contracted product supply system 100 is connected to a client device 101 and a server 102 through a network 140 such as the Internet, LAN, WAN or the like so that communications can be mutually performed among them.

The contracted product supply system 100 is a system for supplying software products corresponding to a contract content to a user (contractant) who concludes a contract with a maker for selling software products such as OS, applications, etc. In this case, a computer main body (client device 101) and software products are sold as a package (set) to a contractant.

The client device 101 (only one device is illustrated in FIG. 1) is a computer device used by a contractant. The client device 101 is supplied from a maker to the contractant together with CD-ROM 110. An identification seal 120 unique to the contractant is attached to the client device 101.

A two-dimensional code in which identification information of the client device 101 and a MAC address are recorded is printed on the identification seal 120. The URL of the server 102 is recorded in the two-dimensional code. An OS which can execute the operations required to implement the contracted product supply system 100 is installed in the client device 101.

The server 102 is a computer device for managing contract information concerning the software products. This server 102 has a contract information DB (data base) 130 for holding the contract information and the identification information of each client device 101 in association with each other.

Here, the general outline of the contracted product supply system 100 will be described. First, the contractant installs product information recorded in CD-ROM 110 into the client device 101 (1). All software products which can be contracted between the maker and the contractant are recorded in CD-ROM 110 but are only permitted to be used when specific contract information is given.

Thereafter, the URL of the server 102 is obtained from the identification seal 120 attached to the client device 101 by using a reading function of a portable communication terminal 103 (2). By executing the URL (3), the identification information and the MAC address recorded in the two-dimensional code of the identification seal 120 are sent to the server 102 (4).

At this time, an IP address allocated to the client device 101 and a password for access to the server 102 are indicated. Specifically, for example, the user may operate the portable communication terminal 103 to indicate the IP address attached to the client device 101 and the access password.

Thereafter, in the server 102, contract information associated with the notified identification information is extracted from the contract information DB 130 (5). Furthermore, the extracted contract information is transmitted from the server 102 to the client device 101 (6). Specifically, the server 102 implements VPN (Virtual Private Network) connection with the client device 101 by using the above IP address, and transmits the contract information to the client device 101.

At this time, it is judged whether the MAC address obtained in the sequence of the VPN connection is coincident with the MAC address sent to the server 102. As a result, only when both the MAC addresses are coincident with each other, is the contract information transmitted to the client device 101. Thus, erroneous transmission of the contract information can be prevented.

Finally, in the client device 101, permission to use the contracted software products is certified by using the contract information transmitted from the server 102 to set a license of the contracted software products (7). Then, the contractant can use the contracted software products in the client device 101.

As described, according to this embodiment, a license of contracted software products among installed software products is set by using the contract information inherent to the contractant which is transmitted from the server 102 to the client device 101, whereby a working load and a working time required to install software products can be reduced and shortened.

When the contract content is changed, revised contract information is transmitted from the server 102 to the client device 101 of the contractant. As a result, in the client device 101, uninstall and install of software products are automatically executed in accordance with the content of the changed contract. Accordingly, the working load and working time required for the install work of the software products after the contract is changed can be reduced and shortened.

(Recording Content of CD-ROM)

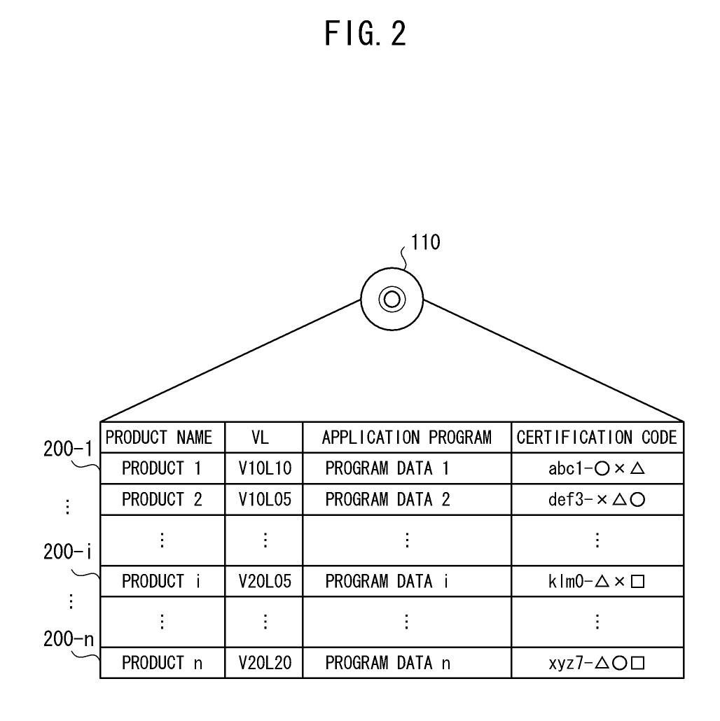

Next, the recording content of the CD-ROM 110 shown in FIG. 1 will be described. FIG. 2 is a diagram showing the recording content of the CD-ROM. In FIG. 2, product information pieces 200-1 to 200-n concerning all software products 1 to n which can be contracted between a maker and each contract are shown.

Specifically, each of the product information pieces 200-1 to 200-n has a product name, VL (Version Level) information, an application program and a certification code for every software product 1 to n. The product name is the name of the software product. The VL information represents the version level of the software product. For example, when the function of the software product is updated (for example, addition of a function, correction of bugs or the like), the number of the VL is increased.

The application program is program data of the software product. The certification code is authentication information used for authentication processing of the contractant. Here, when product information 200-i is cited as an example, the certification code has the VL information “V20L05” concerning a software product i, an application program “program data i” and a certification code “klm0-ΔX□”.

(Storage Content of Contract Information DB130)

Next, the storage content of the contract information DB130 shown in FIG. 1 will be described.

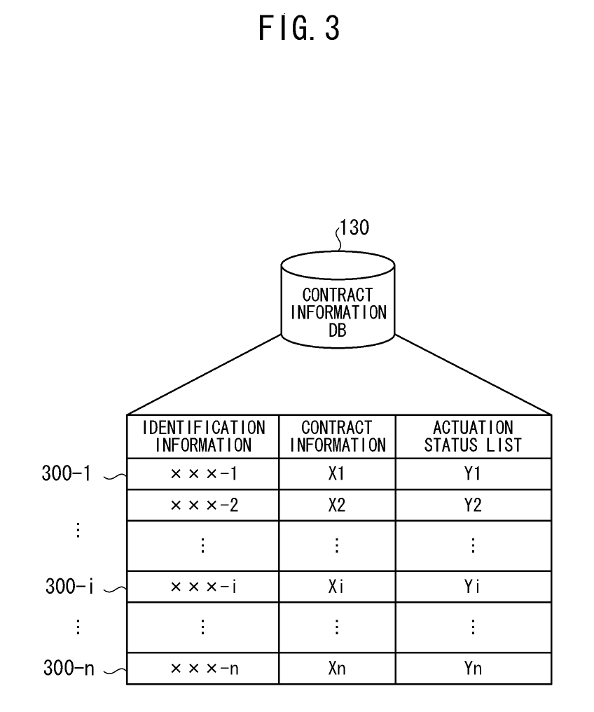

FIG. 3 is a diagram showing the storage content of the contract information DB. In FIG. 3, the contract information DB 130 holds identification information, contract information and contractant information 300-1 to 300-n concerning an actuation status list for every contractant.

The identification information is information for identifying the client device 101. The user (contractant) of the client device 101 can be specified from this identification information. The contract information is information for permitting use of contracted software products. The actuation status list is information representing the actuation status of the contracted software products.

Here, when the contractant information 300-i is cited as an example, it has contract information Xi and actuation status list Yi of a contractant who is specified from identification information “xxx-i”. The details of the contract information Xi and the actuation status Yi will be described later. When the contract content is changed, the storage content of the contract information DB130 is altered in accordance with the storage content every time the contract content is changed.

(Hardware Construction of Computer Device)

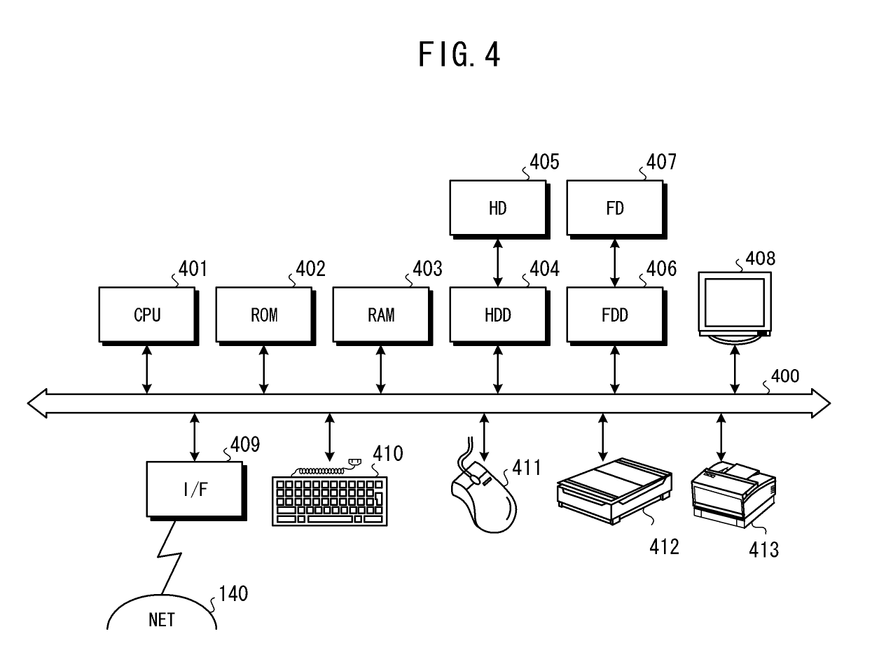

Next, the hardware construction of the client device 101 and the server 102 (in this case, merely referred to as “computer device”) shown in FIG. 1 will be described. FIG. 4 is a block diagram showing the hardware construction of the computer device.

In FIG. 4, the computer device has CPU 401, ROM 402, RAM 403, HDD (hard disk drive) 404, HD (hard disk) 405, FDD (flexible disk drive) 406, FD (flexible disk) 407 as an example of a detachable recording medium, a display 408, an I/F (interface) 409, a keyboard 410, a mouse 411, a scanner 412 and a printer 413. Furthermore, the respective constituent elements are connected to one another through a bus 400.

Here, CPU 401 controls the overall computer device. ROM 402 stores programs such as a boot program, etc. RAM 403 is used as a work area of CPU 401. HDD 404 controls read/write of data from/into HD 405 under the control of CPU 401. HD 405 stores data written under the control of HDD 404.

FDD 406 controls read/write of data from/into FD 407 under the control of CPU 401. FD 407 stores data written under the control of FDD 406 and makes the computer device read data stored in FD 407.

CD-ROM (CD-R, CD-RW), MO, DVD (Digital Versatile Disk) a memory card or the like may be used as the detachable recording medium in place of FD 407. The display 408 displays a cursor, icons, a tool box and data such as a document, an image, function information, etc. For example, CRT, a TFT liquid crystal display, a plasma display or the like may be adopted as the display 408.

I/F 409 is connected to the network 140 such as the Internet or the like through a communication line, and further connected to other devices through the network 140. I/F 409 serves as an interface to the network 140, and controls data input/output from/to an external device. For example, a modem, a LAN adaptor or the like may be adopted as I/F 409.

The keyboard 410 has keys for inputting characters, numbers, various kinds of instructions, etc., and performs data input. A touch panel type input pad or ten keys may be adopted. The mouse 411 moves the cursor, selects a range, moves a window, changes the size of the window, etc. A track ball, a joy stick or the like may be used insofar as it has the same function as a pointing device.

A scanner 412 optically reads an image, and reads the image data into the device. The scanner 412 may be provided with an OCR function. A printer 413 prints image data and document data. A laser printer, an ink jet printer or the like may be adopted as the printer 413.

(Functional Construction of Contracted Product Supply System)

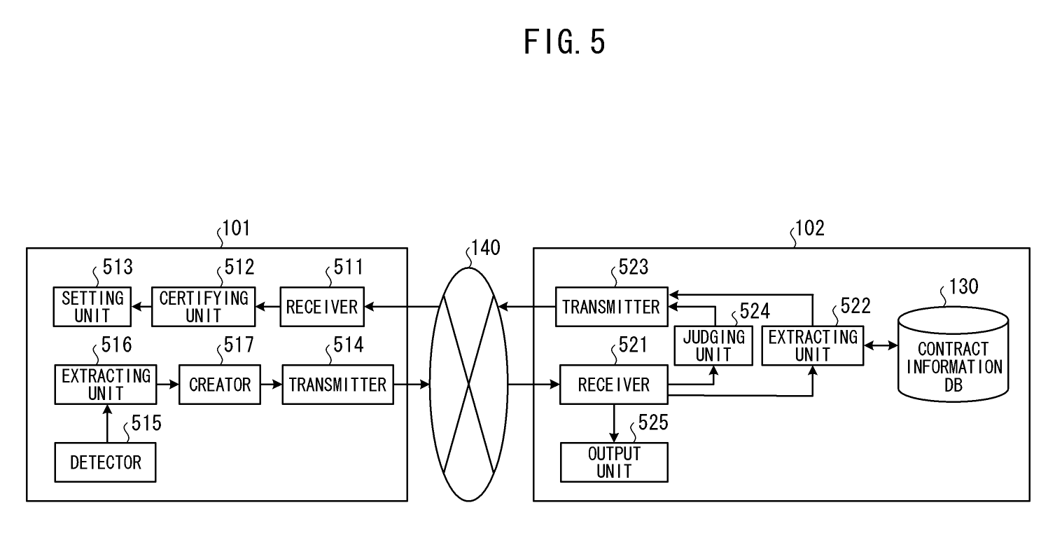

Next, the functional construction of the contracted product supply system 100 shown in FIG. 1 will be described. FIG. 5 is a block diagram showing the functional construction of the contracted product supply system. First, the functional construction of the client device 101 will be described. In FIG. 5, the client device 101 is equipped with a receiver 511, a certifying unit 512, a setting unit 513, a transmitter 514, a detector 515, an extracting unit 516 and a creator 517.

These functions 511 to 517 can be implemented by making the CPU execute programs concerning the functions 511 to 517 stored in the storage unit of the client device 101 or by the input/output I/F. Furthermore, the output data from the respective functions 511 to 517 are held in the storage unit. The function of each connection destination indicated by an arrow in FIG. 5 is assumed to be implemented by making the CPU read from the storage unit the output data from the function of a connection source and execute the program concerning the function concerned.

In the client device 101 is pre-installed software products which are permitted to be used when specific contract information is given. The software products contain application programs such as a document creating software, a payroll accounting software, a ledge sheet processing software, etc. Specifically, for example, software products 1 to n recorded in CD-ROM 110 are installed in the client device 101.

The specific contract information is certification information used for the certification processing of the contract. Specifically, for example, they are certification codes which are individually associated with the respective software products 1 to n shown in FIG. 2. The certification codes are stored in the storage unit such as ROM 402 or RAM 403 as a result of the presence of the product information 200-1 to 200-n.

In this case, it is assumed that the product information 200-1 to 200-n are installed from CD-ROM 110, but the present invention is not limited to this case. For example, the product information 200-1 to 200-n may be down-loaded from an external computer device and installed into the client device 101.

First, the receiver 511 receives contract information for permitting use of contracted software products out of installed software products from the server 102, which manages the contract information concerning the software products. The contract information includes certification information used for the certification processing of the contractant, and there are contract information pieces X1 to Xn held in the contract information DB 130, for example.

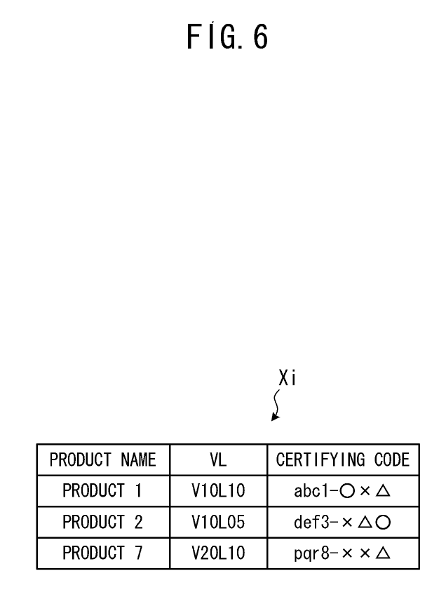

FIG. 6 is a diagram showing a specific example of the contract information. In FIG. 6, the contract information Xi is information for permitting a contractant specified from identification information “xxx-I” to use contracted software products. Specifically, the contract information Xi has VL information and certifying codes concerning the software products 1, 2 and 7.

The certifying unit 512 certifies the permission to use the contracted software products on the basis of the above specific contract information and the contract information received by the receiver 511. Specifically, for example, when the contract information Xi is received by the receiver 511, the permission to use the software products is certified on the basis of the certifying codes of the software products 1, 2 and 7 and the certification codes of the software products 1, 2 and 7 stored in the storage unit.

In this case, it is judged whether the certifying codes of the software products 1, 2 and 7 are coincident with the certification codes of the software products 1, 2 and 7, thereby certifying permission to use the contracted software products. For example, the certifying code “abc1-OXΔ” of the software product 1 and the certification code “abc1-OXΔ” of the software product 1 are coincident with each other, and thus permission to use the software product 1 is certified.

A method of certifying permission to use the contracted software products is not limited to the above method. For example, a license of contracted software products maybe given to the contractant by utilizing an existing security technique such as a secrete key, a public key, an electronic signature or the like.

The setting unit 513 sets a license of the contracted software products which are certified by the certifying unit 512. Specifically, when the certifying code and the certification code are coincident with each other, the restriction (key) needed to use the software products 1, 2 and 7 is released, and the software products 1, 2 and 7 are set to a usable state (key-opened state).

As described above, the license of the contracted software products in the installed software products can be automatically set by using the contract information of the contractant which is transmitted from the server 102 to the client device 101.

The transmitter 514 transmits to the server 102 an inquiry about whether the functions of the contracted software products have been updated. Specifically, for example, the presence or absence of the update may be determined by transmitting to the server 102 the VL information of the contracted software products set by the setting unit 513.

Furthermore, the receiver 511 receives update information of the contracted software products from the server 102 when the functions of the contracted software products are updated as a result of the transmission of the inquiry from the transmitter 514. The update information updates program data for reflecting additional functions and defect correction.

When the receiver 511 receives the update information, the update information may be automatically reflected when the client device 101 is rebooted. Furthermore, the inquiry from the transmitter 514 may be automatically transmitted every preset period. Accordingly, manual work when the latest VL is released is unnecessary, and the contracted software products can have the latest VL.

The detector 515 detects an operation object operating within a predetermined period. The operation object is a file indicated as an operation target, for example. Specifically, the detector 515 detects a file operating within a predetermined period by referring to file information stored on the file system of the client device 101, for example.

The predetermined period may be preset or freely set. Specifically, the user of the client 101 may set a period by using the keyboard or the mouse 411 shown in FIG. 4.

Specifically, a specific term from Jan. 1, 2006 to Mar. 31, 2006 (hereinafter merely expressed as “2006/01/01 to 2006/03/31”) may be set, or the operation object may be detected periodically by setting a start date and a term (for example, Jan. 1, 2006 is set as the start date and every three months thereafter).

The extracting unit 516 extracts a software product associated with the operation object detected by the detector 515. Specifically, for example, the extracting unit 516 extracts the software product associated with the operation object detected by the detector 515 by using a table list for associating the software products and the operation objects.

The table list for associating the software products and the operation objects may be obtained from the server 102 together with the contract information, or obtained from an external device (not shown), by a user's input operation or by installation from CD-ROM 110.

The creator 517 creates an actuation status list representing software products used within a predetermined term on the basis of the extraction result extracted by the extracting unit 516. Here, the specific processing content of the detector 515, the extracting unit 516 and the creator 517 will be described. The predetermined term is assumed to be set to “2006/01/01 to 2006/03/31”.

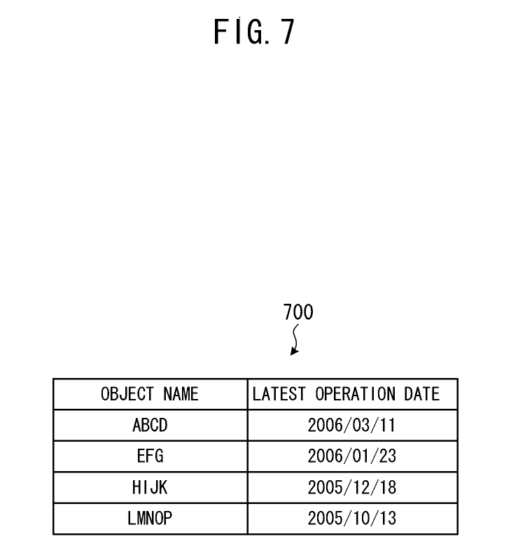

First, the detector 515 detects a file operating within the predetermined term by referring to the file information stored in the file system. FIG. 7 is a diagram showing a specific example of the file information. In FIG. 7, file information 700 represents the object name and the latest operation date of the operation object operating on the computer of the client device 101.

In this case, the detector 515 detects operation objects “ABCD” and “EFG” whose latest operation dates are within the term “2006/01/01 to 2006/03/31”. Thereafter, the extracting unit 516 extracts the software products associated with the operation objects “ABCD” and “EFG” by using the table list for associating the software products and the operation objects.

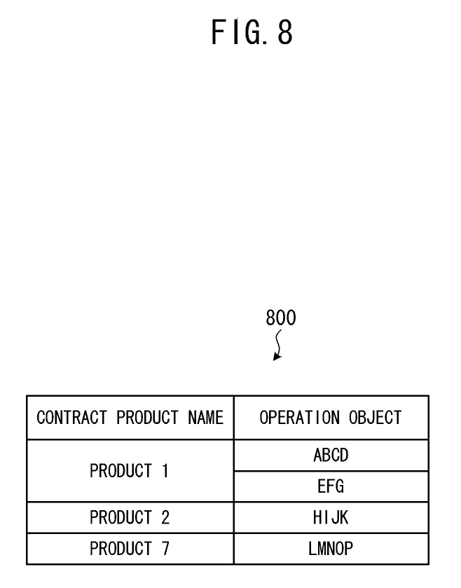

FIG. 8 is a diagram showing a specific example of the table list for associating the software products and the operation objects. In FIG. 8, the contracted product name and the operation object are shown in association with each other for every contracted software product in the table list 800. Specifically, for example, when the software product 1 is used, it means that the operation object “ABCD” or “EFG” operates.

There is a case where when some software product is used, another software product must be necessarily used in combination. Therefore, by using the table list representing the relevancy of software products, the extracting unit 516 may extract the software product associated with the operation object detected by the detector 516.

The table list representing the relevancy of the software products may be obtained from the server 102 together with the contract information, for example. Or, it maybe obtained from an external device (not shown), by a user's input operation or by installation from CD-ROM 110.

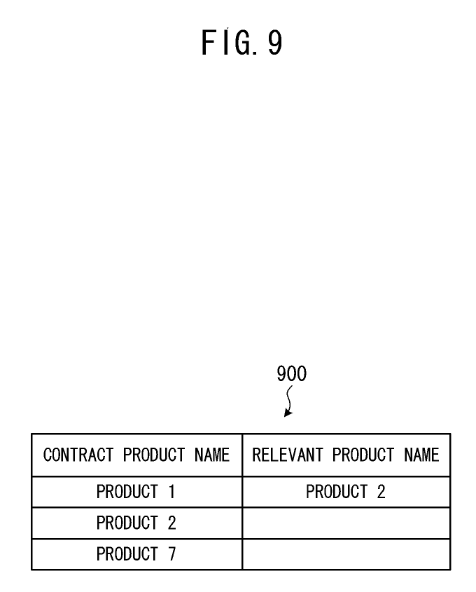

FIG. 9 is a diagram showing a specific example of the table list representing the relevancy of the software products. In FIG. 9, software products having the relevancy to each contracted software product are shown for every contracted software product in the table list 900. Specifically, a software product 1 and a software product 2 are relevant to each other, and it means that the software product 2 is necessarily used when the software product 1 is used.

In this case, the extracting unit 516 extracts the software product 1 associated with the operation objects “ABCD” and “EFG” detected by the detector 515, and also extracts the software product 2 having the relevancy to the software product 1. Thereafter, the creator 517 creates the actuation status list representing the software products 1, 2 used within the term “2006/01/01 to 2006/03/31” on the basis of the extraction result extracted by the extracting unit 516.

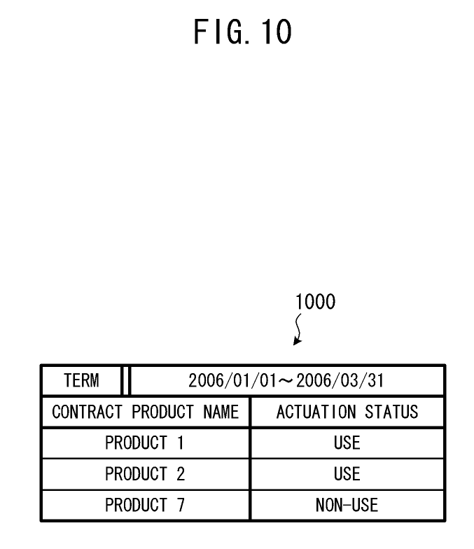

FIG. 10 is a diagram showing a specific example of the actuation status list. In FIG. 10, the actuation status within the term “2006/01/01 to 2006/03/31” concerning the contracted software products 1, 2 and 7 is shown in an actuation status list 1000. Specifically, it is indicated that the software products 1 and 2 out of the contracted software products 1, 2 and 7 are used within the term.

Furthermore, the transmitter 514 transmits the actuation status list (for example, the actuation status list 1000) created by the creator 517 to the server 102. The actuation status list transmitted to the server 102 by the transmitter 514 is displayed on the display 408 of the server 102, for example.

When the contract content is changed, the contract information after the change of the contract content is transmitted from the server 102. Then, the receiver 511 receives the changed contract information from the server 102. Thereafter, software products are automatically uninstalled or installed on the basis of the changed contract information received by the receiver 511.

Accordingly, the working load imposed by installation of the software products when the contract is changed can be reduced, and the working time for installation can be shortened. At a later time, there is no download of software products to be newly added (because they have been already installed), and thus increase of communication traffic due to the change of the contract can be prevented.

Next, the functional construction of the server 102 will be described. In FIG. 5, the server 102 has a receiver 521, an extracting unit 522, a transmitter 523, a judging unit 524 and an output unit 525.

These functions 521 to 525 can be implemented by making the CPU execute programs concerning the functions 521 to 525 stored in the storage unit of the server 102 or by the input/output I/F. The output data from the respective functions 521 to 525 are held in the storage unit. Furthermore, the function of each connection destination indicated by an arrow in FIG. 5 is assumed to be implemented by making the CPU read out from the storage unit the output data from a connection source and execute the program concerning the function concerned.

First, the receiver 521 receives identification information of the client device 101 installed with software products which are permitted to be used when specific contract information is given. The identification information is information for identifying the client device 101. This identification information is recorded on an identification seal (for example, an identification seal 120) on which the identification code such as a bar code, a QR code or the like is printed.

Specifically, for example, the identification seal 120 attached to the client device 101 is read out by using the reading function of the portable communication terminal 103 shown in FIG. 1 to send the identification information recorded in the identification seal 120 to the server 102. As a result, the receiver 521 receives the identification information of the client device 101 from the portable communication terminal 103.

Accordingly, access to the server 102 by a simple procedure can be implemented, and also an unauthorized access to the server 102 can be prevented because the IP address of the server 102 is not directly presented.

The extracting unit 522 extracts the contract information associated with the identification information received by the receiver 521 from the contract information DB 130 for holding the contract information concerning the software products. Specifically, for example when the identification information “XXX-i” is received by the receiver 521, the contractant information 300-i is extracted from the contract information DB 130. More specifically, the contract information Xi (see FIG. 6) is extracted from the contractant information 300-i.

The transmitter 523 transmits the contract information extracted by the extracting unit 522 to the client device 101. Specifically, the contract information Xi extracted by the extracting unit 522 is transmitted to the client device 101. As a result, permission to use contracted software products out of the installed software products is certified on the basis of the contract information transmitted from the transmitter 514 and the specific contract information in the client device 101.

Furthermore, the transmitter 523 transmits changed contract information to the client device 101 when the storage content of the contract information DB 130 is changed. That is, when the contract content is changed, the changed contract information is transmitted to the client device 101 every time the contract content is changed. The changed contract information may be automatically transmitted, for example, when the storage content of the contract information DB 130 is changed or transmitted at any time in accordance with the user's input operation.

The receiver 521 receives from the client device 101 an inquiry about whether the functions of the contracted software products have been updated. Specifically, the receiver 521 receives the information for specifying the product names and VL information of the contracted software products from the client device 101. More specifically, the receiver 521 may receive the contract information Xi from the client device 101 together with the update inquiry.

The judging unit 524 judges on the basis of the update information concerning the contracted software products whether the functions of the contracted software products have been updated as a result of the reception of the inquiry by the receiver 521. Here, a specific example of the update information concerning the software products will be described.

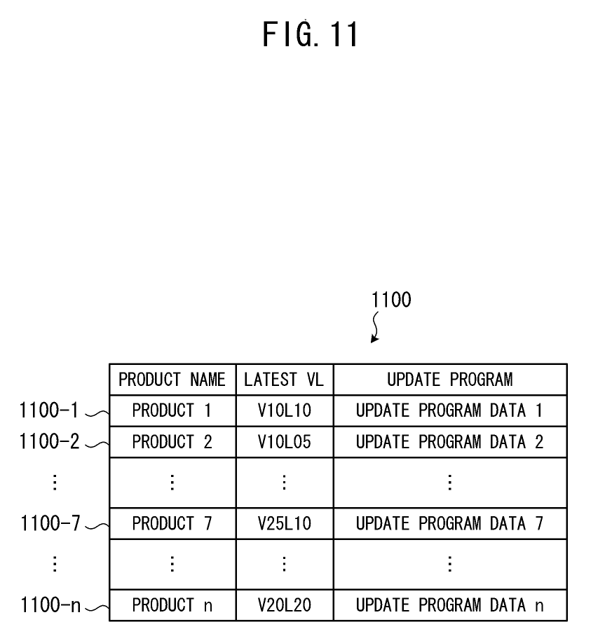

FIG. 11 is a diagram showing a specific example of an update information list. In FIG. 11, update information 1100-1 to 1100-n concerning software products 1 to n are shown in an update information list 1100. Specifically, the update information 1100-1 to 1100-n has the product name, the latest VL information and the update program for every software product 1 to n.

The product name is the name of the software product. The latest VL information represents the version level of the latest software product. The update program is an update program concerning the latest software product, and for example, it is program data supplied as an upgrade or an update.

The judging unit 524 refers to the update information list 1100 to judge whether the functions of the contracted software products have been updated. Here, it is assumed that the contract information Xi is received from the client device 101 by the receiver 521 together with the update inquiry.

In this case, update of the function of the software products 7 is judged by referring to the VL information of the software products 1, 2 and 7 specified from the contract information Xi and the latest VL information of the software products 1, 2 and 7 specified from the update information 1100-1, 1100-2 and 1100-7. Specifically, the version of the software product 7 is updated from V20 to V25.

The transmitter 523 transmits update information of contracted software products to the client device 101 when it is found by the judging unit 524 that the contracted software products have been updated. In the example described above, the transmitter 523 transmits the update information 1100-7 of the software product 7 to the client device 101.

Furthermore, the receiver 521 receives the actuation status list (for example, the actuation status list 1000) representing the software products used in the client device 101 within the predetermined term. The actuation status list received by the receiver 521 is held in the contract information DB 130 in association with the identification information of the client device 101.

The output unit 525 outputs the actuation status list received by the receiver 521. The output style of the output unit 525 may be a screen display based on the display 408, a print output based on the printer 413, a data output (storage) to a memory, or transmission to an external computer device.

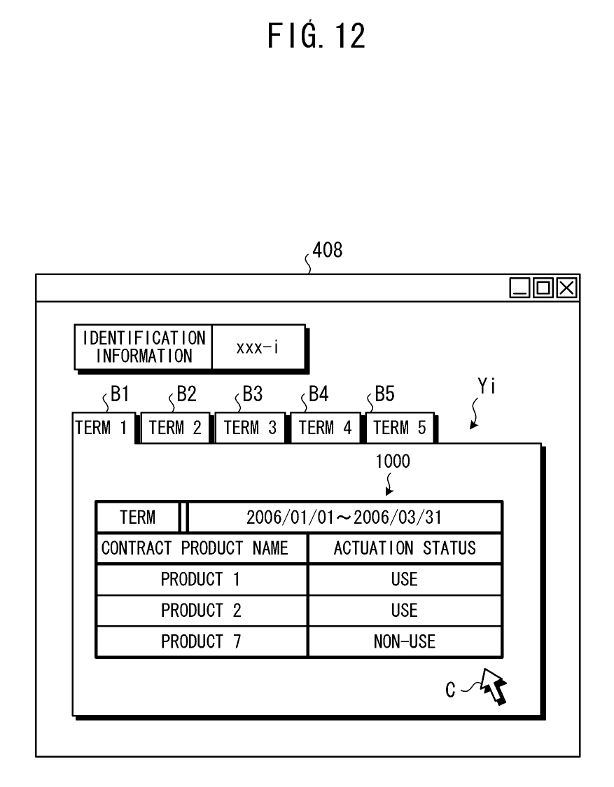

Here, a screen example of the actuation status list displayed on the display 408 by the output unit 525 will be described. FIG. 12 is a diagram showing the screen of the display. In FIG. 12, the actuation status list Yi of a contractant specified from the identification “XXX-i” is displayed on the display 408.

The actuation status list representing the actuation statuses of the software products within the terms 1 to 5 can be displayed by moving a cursor C and clicking each of buttons B1 to B5 on the display 408. In this case, by clicking the button B1, the actuation status list 1000 representing the actuation statuses of the software products 1, 2 and 7 within the term 1 is displayed.

The user can grasp the actuation statuses of the software products used within the terms 1 to 5 by referring to the actuation status list (for example, the actuation status list 1000) displayed on the display 408. Specifically, in the term 1, the user can grasp the software product 7 which is contracted, but not used, and it can be actively used as reference data when the contract is renewed.

Furthermore, in a case where an inquiry about whether the contracted software products have been updated is received from the client device 101, if there exists a software product which is contracted, but not used, the update information of the software product concerned need not be transmitted to the client device 101 even if the information is updated. Accordingly, transmission/reception of the update information of software products which are not used by the contractant can be omitted.

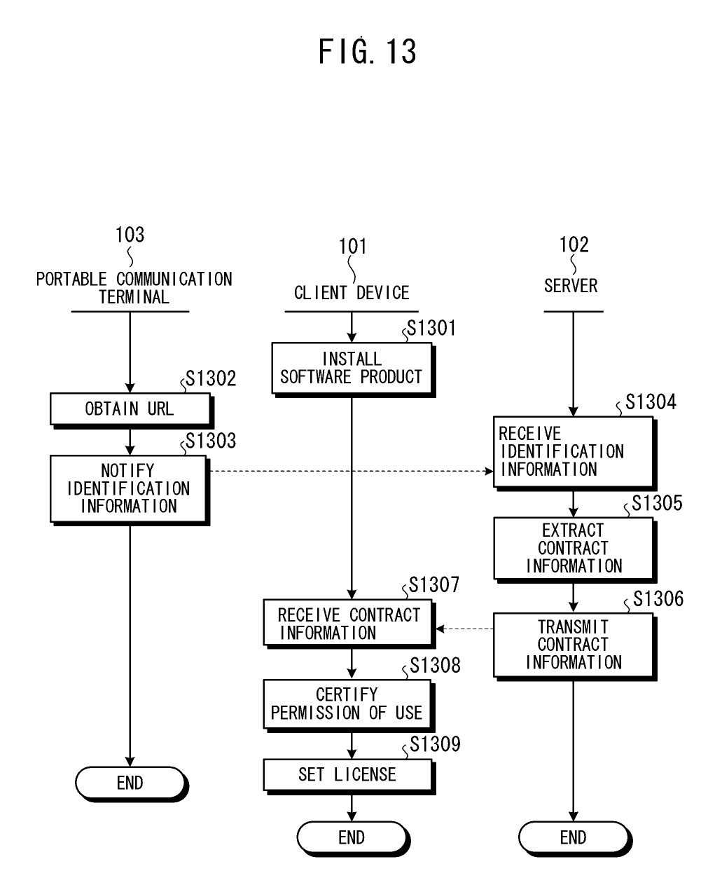

Next, the processing flow of the contracted product supply system according to this embodiment will be described. FIG. 13 is a sequence diagram showing an example of the processing flow of the contracted product supply system. In FIG. 13, the software products recorded in CD-ROM 110 are first installed by the client device 101 (step S1301).

The URL of the server 102 is obtained from the identification seal 120 attached to the client device 101 by the portable communication terminal 103 (step S1302), and the thus-obtained URL is executed, whereby the identification information of the client device 101 is sent to the server 102 (step S1303).

Thereafter, the identification information is received from the portable communication terminal 103 by the receiver 521 of the server 102 (step S1304). The contract information associated with the identification information received by the receiver 521 is extracted by the extractor 522 of the server 102 from the contract information DB 130 (step S1305).

Furthermore, the contract information extracted by the extracting unit 522 is transmitted to the client device 101 by the transmitter 523 of the server 102 (step S1306). Thereafter, the contract information from the server 102 is received by the receiver 511 of the client device 101 (step S1307), and permission to use the contracted software products is certified on the basis of the specific contractor and the contract information received by the receiver 511 by the certifying unit 512 (step S1308).

Finally, a license for the contracted software products certified by the certifying unit 512 is set by the setting unit 513 of the client device 101 (step S1309), and a series of processing based on this sequence is finished.

As described above, by using the contract information unique to the contractant which is transmitted from the server 102 to the client device 101, the license (the permission to use) for the contracted software products out of the installed software products can be automatically set. Furthermore, access to the server 102 can be implemented by a simple procedure using the reading function of the portable communication terminal 103. At this time, the IP address of the server 102 is not directly presented, and thus the server 102 can be prevented from being unnecessarily accessed.

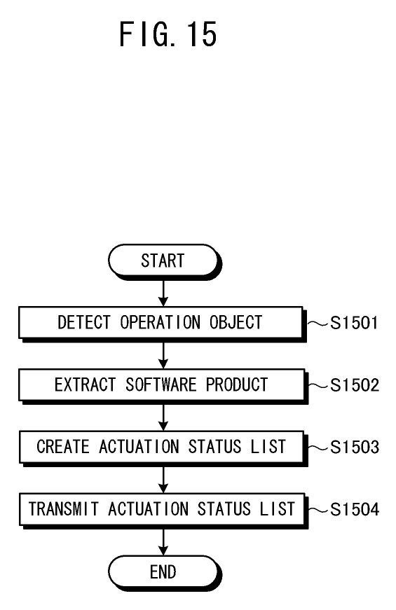

Next, the update processing flow of updating the functions of the contracted software products will be described. FIG. 14 is a sequence diagram showing an example of the update processing flow. In FIG. 14, an inquiry about whether the functions of the contracted software products have been updated or not is transmitted from the transmitter 514 of the client device 101 to the server 102 (step S1401).

Thereafter, the inquiry from the client device 101 is received by the receiver 521 of the server 102 (step S1402) and it is determined by the judging unit 524 whether the contracted software products specified from the inquiry received by the receiver 521 have been updated or not (step S1403).

Here, when the contracted software products are updated (step S1403: Yes), the update information of the contracted software products is transmitted to the client device 101 by the transmitter 523 (step S1404).

Thereafter, the update information from the server 102 is received by the receiver 511 of the client device 101 (step S1405), the contracted software products are updated by using the received update information (step S1406), and the series of processing based on this sequence is finished.

Furthermore, in step S1403, when the contracted software products have not been updated (step S1403: No), the series of processing based on this sequence is finished. If the contracted software products are not updated (step S1403: No), a message indicating this fact may be transmitted to the client device 101 by the transmitter 523.

As described above, by automating the inquiry about the presence or absence of the update, the software products can be prevented from missing the update, whereby the contracted software products can be kept to the latest version.

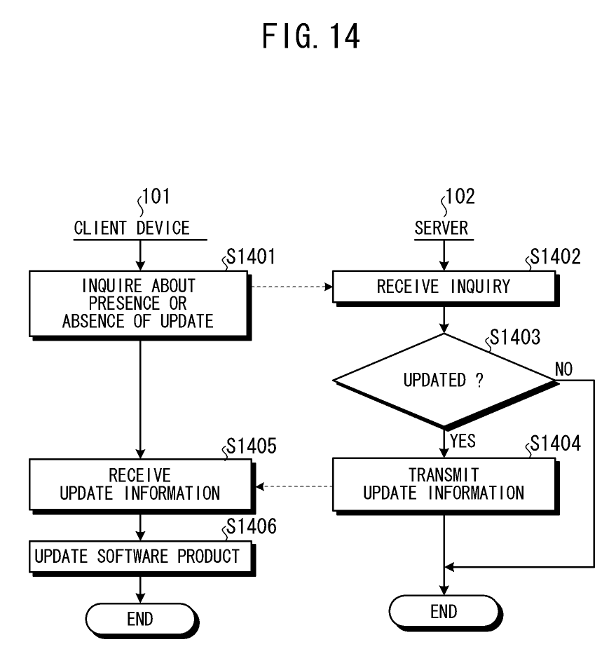

Next, the processing flow of creating the actuation status list in the client device 101 will be described. FIG. 15 is a flowchart showing an example of the processing flow of creating the actuation status list.

In the flowchart of FIG. 15, operation objects operating within a predetermined term are detected by the detector 515 (step S1501). Thereafter, software products associated with the operation objects detected by the detector 515 are extracted from the contracted software products by the extracting unit 516 (step S1502).

On the basis of the extraction result extracted by the extracting unit 516, an actuation status list representing the software products used within the predetermined term is created by the creator 517 (step S1503). Finally, the transmitter 514 transmits the actuation status list created by the creator 517 to the server 102 (step S1504), and the series of processing based on this flowchart is finished.

Accordingly, the sales department or the like of a software maker can grasp the actuation statuses of the software products for every contractant. As a result, the presence or absence of software products which have not been used although they are contracted can be grasped, which can be actively used as reference data when the contract is renewed.

As described above, according to this embodiment, permission to use of software products is collectively given to every contractant, whereby the load imposed by installation of the contracted software products can be reduced and the installation time can be shortened.

The contracted product supply method described with reference to the embodiment can be implemented by executing a pre-prepared program with a computer such as a personal computer, a workstation or the like. This program is recorded in a computer-readable recording medium such as a hard disk, a flexible disk, CD-ROM, MO, DVD or the like, and it is read out from the recording medium and executed by the computer. Furthermore, the program may be a transmission medium which can be distributed through a network such as the Internet or the like.

What is claimed is:

1. A contracted product supply method comprising:
a notifying step of sending identification information of a client device having a software product installed therein to a server that is connected to the client server for mutual communication with each other and management of contract information concerning the software product, the software product concerned being permitted to be used when specific contract information is given by the client device;
an extracting step of extracting contract information associated with the identification information from a contract information data base of the server;
a transmitting step of transmitting the contract information extracted in the extracting step from the server to the client device;
a certifying step of certifying permission to use contracted software products out of software products installed in the client device on the basis of the specific contract information and the contract information transmitted in the stepping step by the client device; and
a setting step of setting a license of the contracted software products certified in the certifying step.

2. The contracted product supply method according to claim 1, wherein the identification information is recorded in an identification seal attached to the client device, and the notifying step reads the identification seal by using a reading function of a portable communication terminal and sending the identification information recorded in the identification seal to the server.

3. The contracted product supply method according to claim 1, further comprising:
an inquiry step of inquiring from the client device to the server whether functions of the contracted software products have been updated or not; and
a download step of downloading update information of the contracted software products to the client device when the functions of the contracted software products have been updated as a result of the inquiry in the inquiry step.

4. The contracted product supply method according to claim 1, further comprising:
an upload step of uploading, from the client device to the server, an actuation status list representing actuation status of the contracted software products used in the client device within a predetermined term; and
an output step of outputting the actuation status list uploaded in the uploading step by the server.

5. A client device in which software products are installed, the software products being permitted to be used when specific contract information is given, comprising:
a receiving unit for receiving contract information permitting use of contracted software products out of installed software products from a server for managing the contract information concerning the software products;
a certifying unit for certifying permission to use the contracted software products on the basis of the specific contractant information and the contract information received by the receiving unit; and
a setting unit for setting a license of the contracted software products certified by the certifying means.

6. The client device according to claim 5, further comprising a transmitting unit for transmitting to the server an inquiry about whether the functions of the contracted software products have been updated or not, wherein the receiving unit receives update information of the contracted software products from the server when the functions of the contracted software have been updated as a transmission result of the inquiry from the transmitting unit.

7. The client device according to claim 5, further comprising:
a detecting unit for detecting an operation object operating within a predetermined term;
an extracting unit for extracting a software product associated with the operation object detected by the detecting unit out of the contracted software products; and
a creating unit for creating an actuation status list representing software products used within the predetermined term on the basis of the extraction result extracted by the extracting unit, wherein the transmitting unit transmits the actuation status list created by the creating unit to the server.

8. A server comprising:
a receiving unit for receiving identification information of a client device in which software products are installed, the software products being permitted to be used when specific contract information is given;
an extracting unit for extracting contract information associated with the identification information received by the receiving unit from a contract information data base for holding contract information permitting use of the software products in association with the identification information; and
a transmitting unit for transmitting the contract information extracted by the extracting unit to the client device.

9. The server according to claim 8, further comprising a judging unit for judging on the basis of update information concerning the contracted software products whether the functions of the contracted software products have been updated or not, wherein the receiving unit receives from the client device an inquiry about whether the functions of the contracted software products have been updated or not, the judging unit judges whether the contracted software products have been updated or not as a reception result of the inquiry by the receiving unit, and the transmitting unit transmits update information of the contracted software products to the client device when it is judged by the judging unit that the contracted software products have been updated.

10. The server according to claim 8, wherein the receiving unit receives from the client device an actuation status list representing software products used in the client device within a predetermined term, and the server further comprises an output unit for outputting the actuation status list received by the receiving unit.

11. A computer-readable recording medium recorded with a licensing program for software products which are installed in a client device and permitted to be used when specific contract information is given, the licensing program being executed by the client device to make a computer function as:
a receiving unit for receiving contract information for permitting use of contracted software products out of the installed software products from a server for managing the contract information concerning the software products;
a certifying unit for certifying the permission to use the contracted software products on the basis of specific contractant information and the contract information received by the receiving part; and
a setting unit for setting a license of the contracted software products certified by the certifying part.

12. A computer-readable recording medium recorded with a contracted product managing program that makes a computer function as:
a receiving unit for receiving identification information of a client device installed with software products which are permitted to be used when specific contract information is given;
an extracting unit for extracting contract information associated with identification information received by the receiving unit from a contract information data base for holding contract information permitting use of the software products in association with identification information; and
a transmitting unit for transmitting the contract information extracted by the extracting unit to the client device.
